(19) United States
(12) Patent Application Publication
(10) Pub. No.: US 2008/0158143 A1
(43) Pub. Date: Jul. 3, 2008

(54) ELECTROPHORETIC DISPLAY APPARATUS AND METHOD FOR MANUFACTURING THE SAME

(76) Inventors: Yeon-Ju Kim, Suwon-si (KR); Kyoung-Ju Shin, Hwaseong-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/955,242

(22) Filed: Dec. 12, 2007

(30) Foreign Application Priority Data
Dec. 28, 2006 (KR) 2006-135789

(51) Int. Cl. G09G 3/34

(52) U.S. Cl. 345/107

(57) ABSTRACT

An electrophoretic display apparatus with reduced malfunction of a gate circuit part caused by external light and enhanced view is presented. The electrophoretic display apparatus includes an array substrate and an electrophoretic layer. The array substrate includes a display area having a thin film transistor (TFT) electrically connected to a gate line and a source line, and a pixel electrode electrically connected to the TFT, and a peripheral area surrounding the display area. The peripheral area has a blocking electrode to block an external light. The electrophoretic layer is attached to the array substrate and has an electrophoretic layer. The view of the displayed image is enhanced by displaying the peripheral area in a black gray scale.

### CROSS-REFERENCE TO RELATED APPLICATIONS

This application claims priority under 35 U.S.C. § 119 to Korean Patent Application No. 2006-135789 filed on Dec. 28, 2006 in the Korean Intellectual Property Office (KIPO), the contents of which are herein incorporated by reference in their entirety.

### BACKGROUND OF THE INVENTION

1. Field of the Invention

The present invention relates to an electrophoretic display apparatus and a method for manufacturing the electrophoretic display apparatus. More particularly, the present invention relates to the electrophoretic display apparatus capable of enhancing driving reliability and viewing ability and the method for manufacturing the electrophoretic display apparatus.

2. Description of the Related Art

Generally, an electrophoretic display apparatus has a reflective type structure whereby it reflects light from an external source to display an image. Particularly, the electrophoretic display apparatus has a microcapsule enclosing a white ink particle with a negative charge, a black ink particle with a positive charge, and a dielectric fluid between two electrodes.

In the electrophoretic display apparatus, an electric field is applied to the two electrodes. White color is displayed when the white ink particle moves in the viewing direction in response to the electric field, and black color is displayed when the black ink particle moves in the viewing direction in response to the electric field. The light from the external source is reflected by the white ink particle that moved in the viewing direction, and the electrophoretic display apparatus displays the image.

### SUMMARY OF THE INVENTION

The present invention provides an electrophoretic display apparatus capable of enhancing driving reliability of a gate circuit and a view of the displayed image.

The present invention also provides a method for manufacturing an electrophoretic display apparatus.

In one aspect, the invention is an electrophoretic display apparatus that includes an array substrate and an electrophoretic layer. The array substrate includes a display area having a thin film transistor (TFT) electrically connected to a gate line and a source line, and a pixel electrode electrically connected to the TFT, and a peripheral area surrounding the display area. The peripheral area has a blocking electrode to block an external light. The electrophoretic layer is attached to the array substrate and has an electrophoretic layer.

In another aspect, the invention is a method for manufacturing an electrophoretic display apparatus. The method entails forming an array substrate including a display area having a TFT, and a peripheral area having a blocking electrode to block an external light and surrounding the display area. Then, an electrophoretic layer including electrophoretic molecules is attached to the array substrate.

According to the present invention, malfunction of the gate circuit part due to light may be prevented, and the resulting view of the image may be enhanced by displaying the border in a black gray scale.

### BRIEF DESCRIPTION OF THE DRAWINGS

The above and other features and advantages of the present invention will become more apparent by describing in detailed embodiments thereof with reference to the accompanying drawings, in which:

FIG. 1 is a plan view illustrating an electrophoretic display apparatus according to an embodiment of the present invention;

FIG. 2 is a cross-sectional view illustrating the electrophoretic display apparatus according to a first embodiment taken along the line I-I′ of FIG. 1;

FIGS. 3A and 3B are sectional views illustrating a method for manufacturing the electrophoretic display apparatus of FIG. 2;

FIG. 4 is a cross-sectional view illustrating the electrophoretic display apparatus according to a second embodiment taken along the line I-I′ of FIG. 1;

FIGS. 5A and 5B are sectional views illustrating a method for manufacturing the electrophoretic display apparatus of FIG. 4;

FIG. 6 is a plan view illustrating an electrophoretic display apparatus according to a third embodiment of the present invention;

FIG. 7 is a cross-sectional view illustrating the electrophoretic display apparatus according to a third embodiment taken along the line II-II′ of FIG. 6; and

FIGS. 8A and 8B are process views illustrating a method for manufacturing the electrophoretic display apparatus in FIG. 7.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

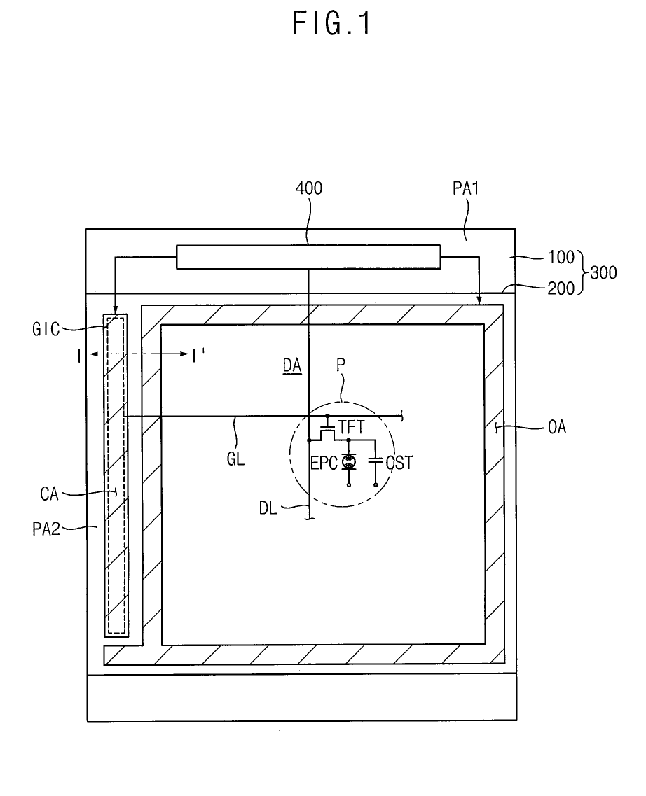

FIG. 1 is a plan view illustrating an electrophoretic display apparatus according to an embodiment of the present invention.

Referring to FIG. 1, the electrophoretic display apparatus includes an electrophoretic display panel 300 and a driving part 400 driving the electrophoretic display panel 300.

The electrophoretic display panel 300 includes an array substrate 100 and an electrophoretic layer 200. The array substrate 100 includes a display area DA and a peripheral area surrounding the display area DA.

Pixel portions P in the display area DA are defined by source lines DL and gate lines GL crossing each other. Each of the pixel portions P includes a thin film transistor TFT electrically connected to the gate and source lines GL and DL corresponding to each pixel portion P, an electrophoretic capacitor EPC electrically connected to the TFT, and a storage capacitor CST electrically connected to the EPC.

The peripheral area includes a peripheral area OA adjacent to the display area DA and surrounding the display area DA and a first peripheral area PA1 on which the driving part 400 is disposed. A portion of the source line DL lies in the first peripheral area PA1, and a portion of the gate lines GL lies on a second peripheral area PA2. The second peripheral area PA2 includes a circuit area CA in which a gate circuit part GIC outputting a gate signal to the gate lines GL is integrated.

A blocking electrode is formed in the peripheral area OA, and a blocking layer covering the gate circuit part GIC is formed in the circuit area CA.

A data voltage corresponding to a black gray scale is applied to the blocking electrode, and the electrophoretic layer displays the black gray scale. As the peripheral area OA is displayed in the black gray scale, the view of an image displayed in the display area DA is enhanced. The blocking layer blocks external light from reaching the gate circuit part GIC formed in the circuit area CA, thus preventing the gate circuit part GIC from being inappropriately activated.

The electrophoretic layer 200 includes a common electrode having a transparent conductive material that is formed on a base substrate having a flexible material, and an electrophoretic layer that is formed on the common electrode. The electrophoretic layer includes electrophoretic molecules having a positive (+) charge and a negative (−) charge. The electrophoretic layer 200 is attached to the display area DA, the first peripheral area PA1 and the peripheral area OA of the array substrate 100.

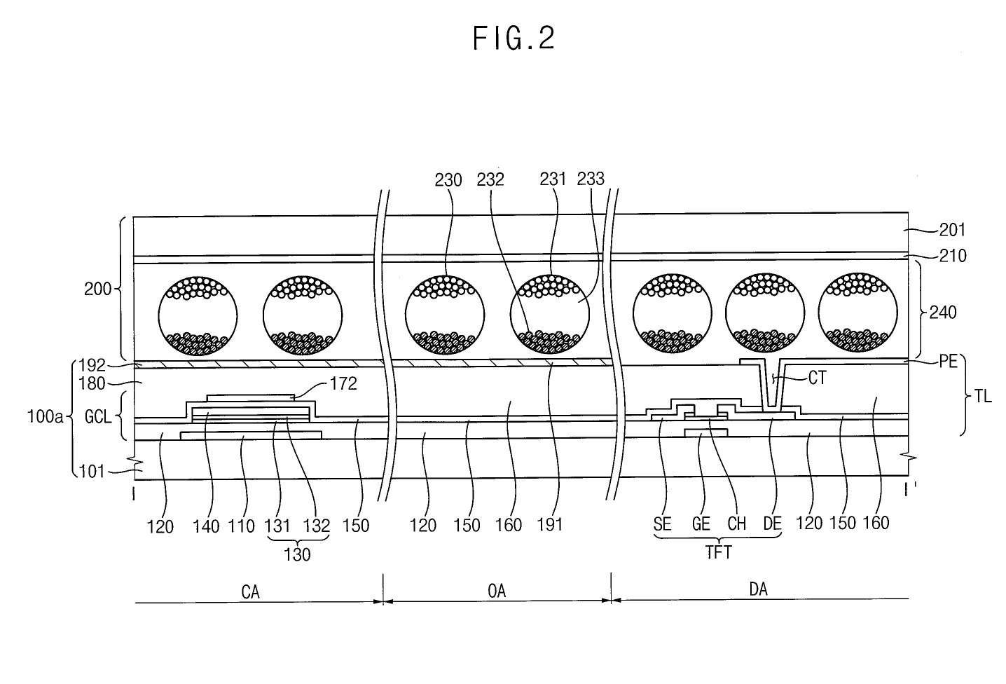

FIG. 2 is a cross-sectional view illustrating the electrophoretic display apparatus according to a first embodiment taken along the line I-I′ of FIG. 1.

Referring to FIGS. 1 and 2, the electrophoretic display apparatus includes an array substrate 100a and the electrophoretic layer 200. The array substrate 100a includes a first base substrate 101, and the first base substrate 101 includes the display area DA, the peripheral area OA and the circuit area CA.

A thin film transistor layer TL is formed in the display area DA. The thin film transistor layer TL includes a gate electrode GE, a gate insulating layer 120, a channel portion CH, a source electrode SE, a drain electrode DE, a protective insulating layer 150, a first organic insulating layer 160 and a pixel electrode PE.

The gate electrode GE extends from a gate line GL, and the gate insulating layer 120 is formed on the gate line GL and the gate electrode GE. The channel portion CH includes an active layer 131 having amorphous silicon a-Si and a resistant contact layer 132 having amorphous silicon (a-Si) doped with N type dopants at a high concentration (n+ a-Si).

The source and drain electrodes SE and DE are formed on the channel portion CH, separated from each other. The source and drain electrodes SE and DE are electrically connected with each other through the channel portion CH. The source electrode DE extends from the source line DL, and the drain electrode DE is electrically connected to the pixel electrode PE through a contact hole CT. Thus, the thin film transistor TFT having the gate electrode GE, the channel portion CH, the source electrode SE and the drain electrode DE, is formed.

The protective insulating layer 150 and the first organic insulating layer 160 are formed on the first base substrate 101 on which the thin film transistor TFT is formed, and includes the contact hole CT that extends to the drain electrode DE. The first organic insulating layer 160 has a transparent organic insulating material.

The pixel electrode PE is formed on the first organic insulating layer 160, to be electrically connected to the drain electrode DE through the contact hole CT.

The gate insulating layer 120, the protective insulating layer 150 and the first organic insulating layer 160 are sequentially formed on the peripheral area OA. A blocking electrode 191 having an opaque metal material is formed on the first organic insulating layer 160. A black gray scale voltage is applied to the blocking electrode 191 to display the black gray scale.

The circuit area CA includes a gate circuit layer GCL electrically connected to the plurality of thin film transistors, a second organic insulating layer 180 and a blocking layer 192.

The gate circuit layer GCL includes a gate metal layer 110, the gate insulating layer 120, the channel layer 130, a source metal layer 140, the protective insulating layer 150 and a contact electrode 172. The gate circuit layer GCL and the thin film transistor layer TL are formed via the same manufacturing process at the same time. The second organic insulating layer 180 includes the transparent organic insulating material.

The blocking layer 192 includes the same opaque metal material as the blocking electrode 191. The blocking layer 192 is formed to cover the gate circuit layer GCL to prevent the light from an external source from being incident on the gate circuit layer GCL. Thus, current leakage by the light in the gate circuit part GIC is prevented. The second organic insulating layer 180 electrically insulates the contact electrode 172 and the blocking layer 192, and planarizes the surface of the circuit area CA similarly to how the first organic insulating layer 160 planarizes the surface of the peripheral area OA.

The electrophoretic layer 200 includes a second base substrate 201, a common electrode 210 and an electrophoretic layer 240.

The second base substrate 201 may include a flexible material. For example, the second base substrate 201 includes a polyethylene terephthalate (PET) having good light transmissivity, heat-resistance, chemical-resistance, mechanical strength and so on.

The common electrode 210 includes a transparent conductive material. The common electrode 210 is across the electrophoretic layer 240 from the pixel electrode PE, and a common voltage is applied to the common electrode 210. The common electrode may include a transparent conductive material, such as indium tin oxide (ITO), indium zinc oxide (IZO), amorphous indium tin oxide (a-ITO), and so on.

The electrophoretic layer 240 includes a plurality of microcapsules 230 and a binder (not shown) binding the microcapsules 230. Each of the microcapsules 230 includes electrophoretic molecules charged with positive (+) and negative (−) charges.

Particularly, each of the microcapsules 230 includes a white ink particle 231 with a negative (−) charge or positive (+) charge, a black ink particle 232 having a charge that is opposite of the charge on the white ink particle 231, and a transparent dielectric 233. For example, in one embodiment, the white ink particle 231 may have a positive (+) charge, and the black ink particle 232 may have a negative (−) charge. The light from the external source is reflected by the white ink particle 231 to display white color.

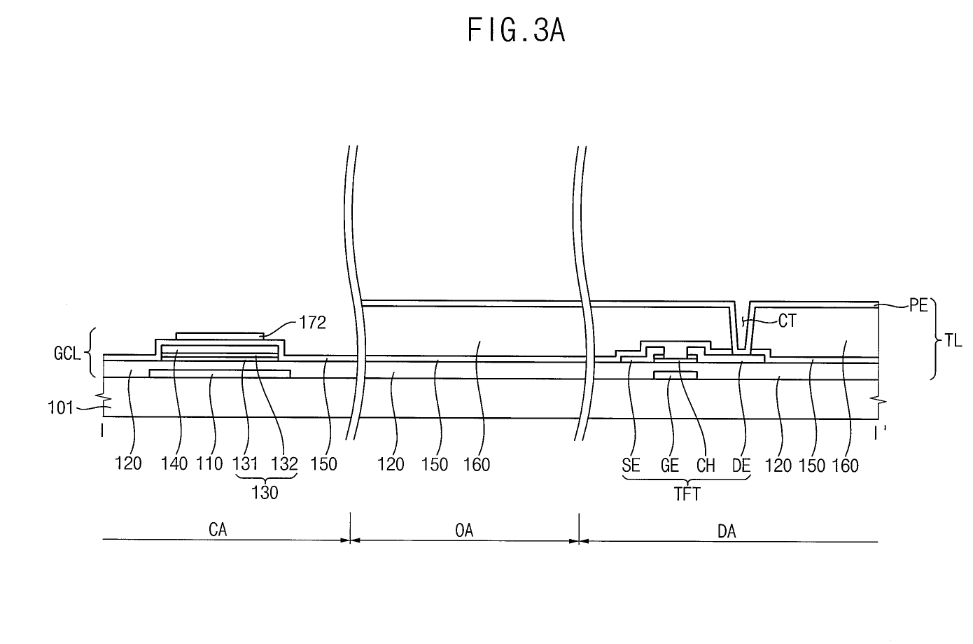

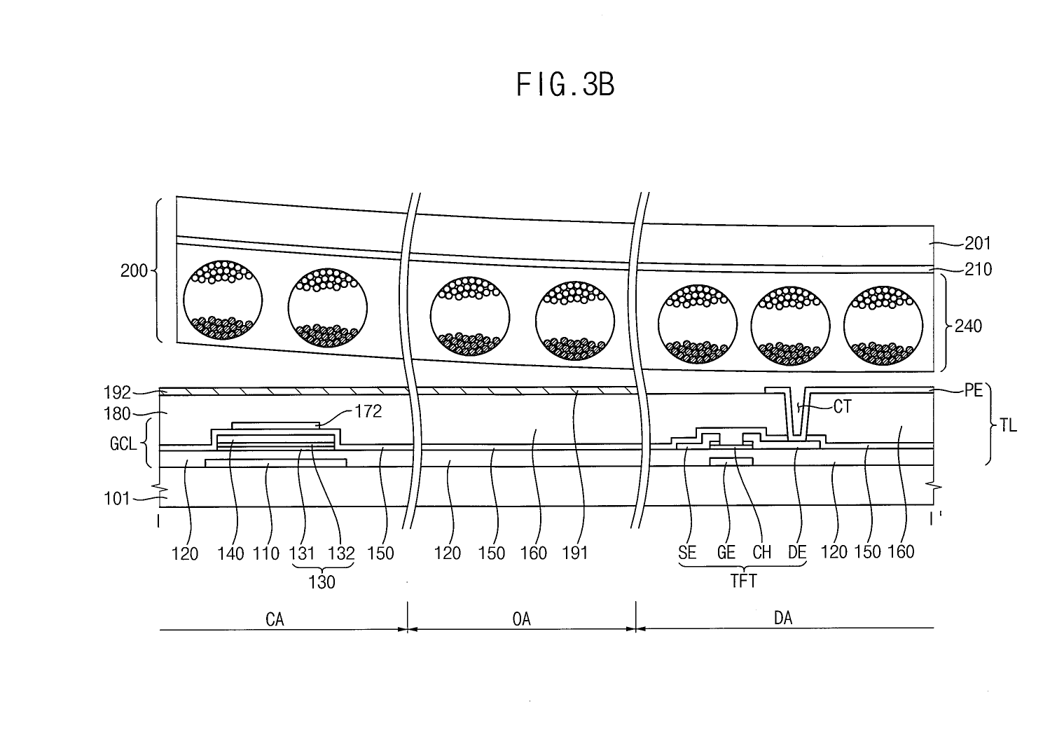

FIGS. 3A and 3B are sectional views illustrating a method for manufacturing the electrophoretic display apparatus of FIG. 2.

Referring to FIGS. 2 and 3A, the thin film transistor layer TL is formed on the first base substrate 101 in the display area DA, and the gate circuit layer GCL is formed in the circuit area CA.

Particularly, a first metal layer is deposited and patterned on the first base substrate 101. Then, the gate electrode GE and the gate line GL are formed in the display area DA, and the gate metal layer 110 is formed in the circuit area CA. The gate metal layer 110 includes the gate electrodes of the plurality of thin film transistors forming the gate circuit part GIC.

The gate insulating layer 120 is formed on the first base substrate 101 on which the gate pattern is formed. The gate insulating layer 120 is formed in the display area DA, the peripheral area OA, and the circuit area CA.

The active layer 131 having amorphous silicon (a-Si) and the resistant contact layer 132 having amorphous silicon doped with N type dopants at a high concentration (n+ a-Si), are sequentially deposited and patterned on the gate insulating layer 120. Then, the channel portion CH is formed in the display area DA, and the channel layer 130 is formed in the circuit area CA. The active layer 131 and the resistant contact layer 132 are not formed in the peripheral area OA.

A second metal layer is deposited and patterned on the first base substrate 101 on which the channel portion CH and the channel layer 130 are formed. Then, the source line DL, the source electrode SE and the drain electrode DE are formed in the display area DA, and the source metal layer 140 is formed in the circuit area CA. The source metal layer 140 includes the source and drain electrodes of the plurality of thin film transistors forming the gate circuit part GIC.

The protective insulating layer 150 is formed on the first base substrate 101 on which the source pattern is formed. The protective insulating layer 150 is formed in the display area DA, the peripheral area OA and the circuit area CA in common.

Then, the first organic insulating layer 160 having the transparent organic insulating material is formed in the display area DA and the peripheral area OA. However, the first organic insulating layer 160 is not formed in the circuit area CA.

The first organic insulating layer 160 and the protective insulating layer 150 formed in the display area DA are patterned to form the contact hole CT. The protective insulating layer 150 and the gate insulating layer 120 formed in the circuit area CA are patterned to form a plurality of contact holes (not shown).

The transparent conductive material is deposited and patterned on the first base substrate 101 on which the contact holes are formed, to form the pixel electrode PE in the display area, and to form the contact electrode 172 in the circuit area CA.

Accordingly, the thin film transistor layer TL is formed in the display area DA, and the gate circuit layer GCL is formed in the circuit area CA. The gate insulating layer 120, the protective insulating layer 150 and the first organic insulating layer 160 are sequentially formed in the peripheral area OA.

Referring to FIGS. 2 and 3B, the second organic insulating layer 180 having the transparent organic insulating material is formed on the first base substrate 101 in the circuit area CA. The second organic insulating layer 180 is formed to cover the contact electrode 172, so that the second organic insulating layer 180 planarizes the surface of the circuit area CA similarly to how the first organic insulating layer 160 planarizes the surface of the peripheral area OA.

The opaque metal material is deposited and patterned on the first organic insulating layer 160 and the second organic insulating layer 180 to form the blocking electrode 191 in the peripheral area OA, and to form the blocking layer 192 in the circuit area CA. A black gray scale data is applied to the blocking electrode 191 to enhance the view of the image displayed in the display area DA. The blocking layer 192 is formed to cover the gate circuit layer GCL, to block the light from reaching the gate circuit layer GCL.

The blocking electrode 191 and the blocking layer 192 are formed to complete the array substrate 100a. The electrophoretic layer 200 having the electrophoretic layer 240 is laminated to be attached to the array substrate 100a. The electrophoretic layer 200 is attached to cover the display area DA, the peripheral area OA and the circuit area CA of the array substrate 100a.

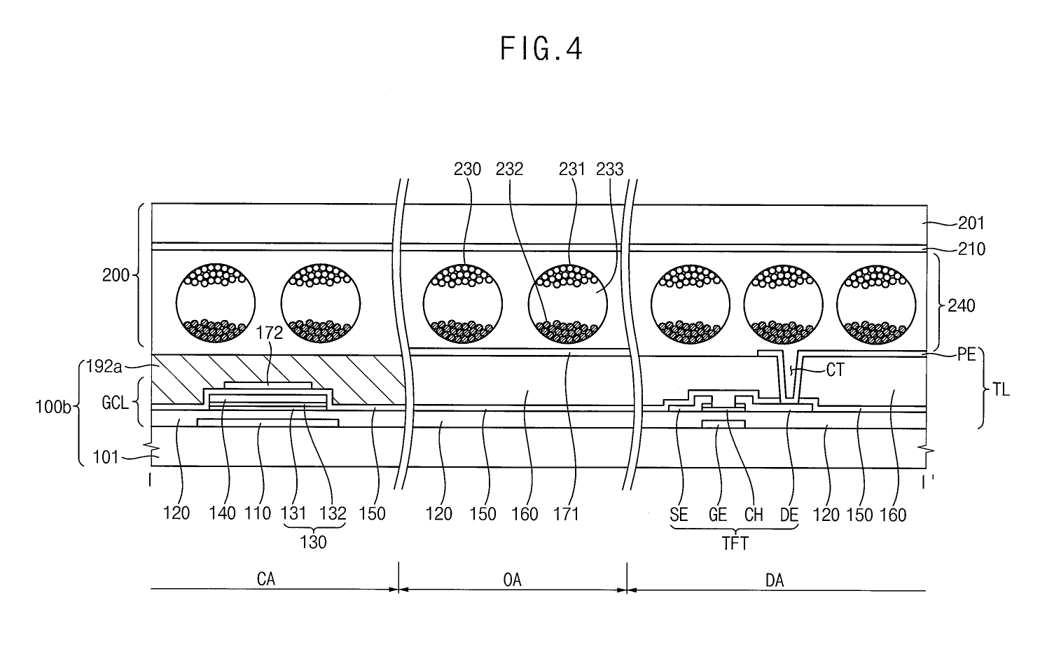

FIG. 4 is a cross-sectional view illustrating the electrophoretic display apparatus according to a second embodiment taken along the line I-I′ of FIG. 1.

Referring to FIGS. 1 and 4, the electrophoretic display apparatus includes an array substrate 100b and the electrophoretic layer 200.

The array substrate 100b includes a first base substrate 101, the first base substrate 101 includes the display area DA, the peripheral area OA and the circuit area CA.

The thin film transistor layer TL is formed in the display area DA. The thin film transistor layer TL includes the gate electrode GE, the gate insulating layer 120, the channel portion CH, the source electrode SE, the drain electrode DE, the protective insulating layer 150, the organic insulating layer 160 and the pixel electrode PE. The thin film transistor layer TL of the present embodiment is substantially the same as that of the embodiment of FIG. 2. Thus, the same reference numerals will be used to refer to the same or like parts as those described in the previous embodiment and any repetitive description will be omitted.

The gate insulating layer 120, the protective layer 150 and the organic insulating layer 160 are sequentially formed in the peripheral area OA, and the blocking layer 171 having the transparent conductive material is formed on the organic insulating layer 160. The blocking electrode 171 and the pixel electrode PE are formed at the same time, and the black gray scale voltage is applied to display black gray scale.

The gate circuit layer GCL electrically connected to the plurality of thin film transistors and the blocking layer 192a are formed in the circuit area CA.

The gate circuit layer GCL includes the gate metal layer 110, the gate insulating layer 120, the channel layer 130, the source metal layer 140, the protective insulating layer 150 and the contact electrode 172. The gate circuit layer GCL is formed by the same manufacturing process as the thin film transistor layer TL at the same time.

The blocking layer 192a includes an opaque organic material. The blocking layer 192a is formed to cover the gate circuit layer GCL, and is formed to have a surface extending from a surface of the organic insulating layer 160 formed in the peripheral area OA. In other words, the surfaces of the blocking layer 192a and the organic insulating layer 160 have the same height with respect to the first base substrate 101. The blocking layer 192a blocks the light from the external source, thus preventing a light leakage current of the gate circuit part GIC. The blocking layer 192a electrically insulates the common electrode 210 of the contact electrode 172 and the electrophoretic layer 200.

The electrophoretic layer 200 includes the second base substrate 201, the common electrode 210 and the electrophoretic layer 240. The electrophoretic layer 200 of the present embodiment is substantially the same as in the embodiment of FIG. 2, and thus any redundant detailed descriptions will be omitted.

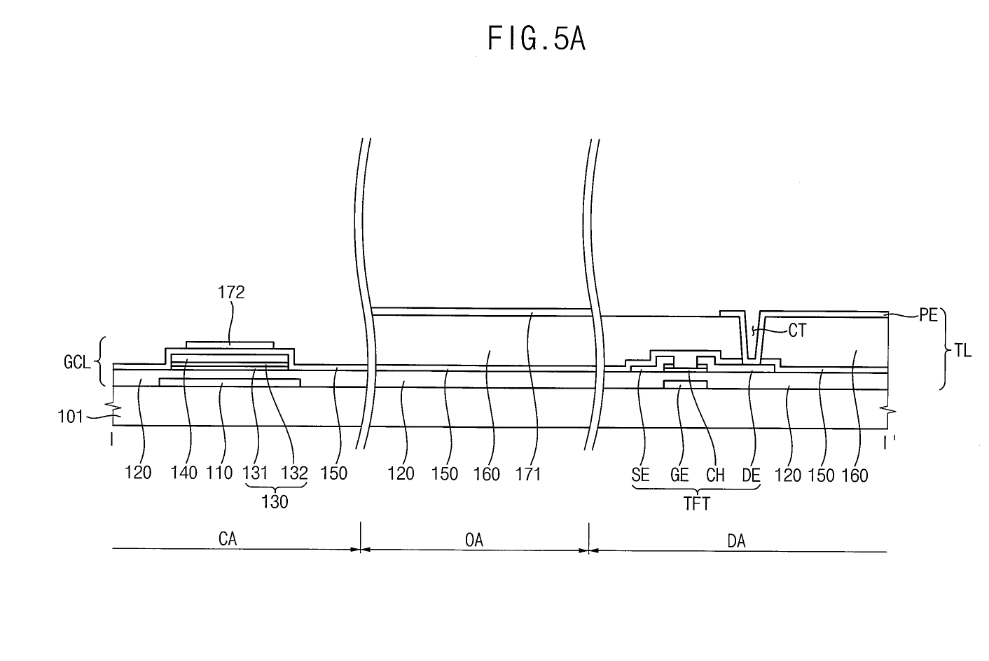

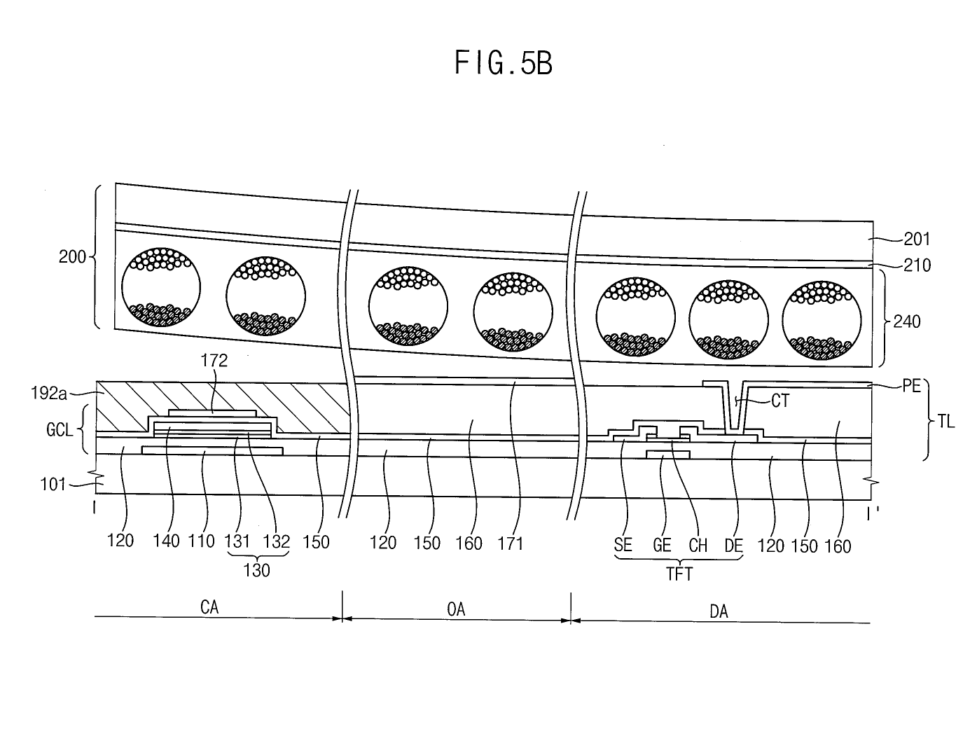

FIGS. 5A and 5B are sectional views illustrating a method for manufacturing the electrophoretic display apparatus of FIG. 4.

Referring to FIGS. 4 and 5A, the first metal layer is deposited and patterned on the first base substrate 101 to form the gate electrode GE and the gate line GL in the display area DA, and to form the gate metal layer 110 in the circuit area CA. The gate metal layer 110 includes the gate electrodes of the thin film transistors forming the gate circuit part GIC.

The gate insulating layer 120 is formed on the first base substrate 101 on which the gate pattern is formed. The gate insulating layer 120 is formed in the display area DA, the peripheral area OA, and the circuit area CA.

The active layer 131 having amorphous silicon a-Si and the resistant contact layer 132 having amorphous silicon doped with N type dopants at a high concentration of n+ a-Si are sequentially deposited and patterned on the gate insulating layer 120 to form the channel portion CH in the display area DA, and to form the channel layer 130 in the circuit area CA. The active layer 131 and the resistant contact layer 132 are not formed in the peripheral area OA.

The second metal layer is deposited and patterned on the first base substrate 101 on which the channel portion CH and the channel layer 130 are formed to form the source line DL, the source electrode SE, and the drain electrode DE in the display area DA, and to form the source metal layer 140 in the circuit area CA.

The protective insulating layer 150 is formed on the first base substrate 101 on which the source pattern is formed. The protective insulating layer 150 is formed in the display area DA, the peripheral area OA, and the circuit area CA.

Then, the organic insulating layer 160 having the transparent organic insulating material is formed in the display area DA and the peripheral area OA. However, the organic insulating layer 160 is not formed in the circuit area CA.

The organic insulating layer 160 and the protective insulating layer 150 formed in the display area DA is patterned to form the contact hole CT, and the protective insulating layer 150 and the gate insulating layer 120 formed in the circuit area CA is patterned to form the plurality of contact holes (not shown).

The transparent conductive material is deposited and patterned on the first base substrate 101 in which the contact holes are formed to form the pixel electrode PE in the display area DA, to form the blocking electrode 171 in the peripheral area OA, and to form the contact electrode 172 in the circuit area CA. The black gray scale voltage is applied to the blocking electrode 171 to enhance the view of the image displayed in the display area DA.

Accordingly, the thin film transistor layer TL is formed in the display area DA, and the gate circuit layer GCL is formed in the circuit area CA. The gate insulating layer 120, the protective insulating layer 150, the organic insulating layer 160 and the blocking electrode 172 are sequentially formed in the peripheral area OA.

Referring to FIGS. 4 and 5B, the blocking layer 192a having an opaque organic insulating material is formed on the base substrate 101 in the circuit area CA. The blocking layer 192a is formed to cover the gate circuit layer GCL, and the thickness of the blocking layer 192a is substantially the same as that of the organic insulating layer 160 formed in the peripheral area OA. The blocking layer 192a blocks the light that may have otherwise reached the gate circuit layer GCL.

The blocking layer 192a is formed to complete the array substrate 10b. The electrophoretic layer 200 having the electrophoretic layer 240 is laminated to be attached to the array substrate 100b. The electrophoretic layer 200 is attached to cover the display area DA, the peripheral area OA and the circuit area CA of the array substrate 100b.

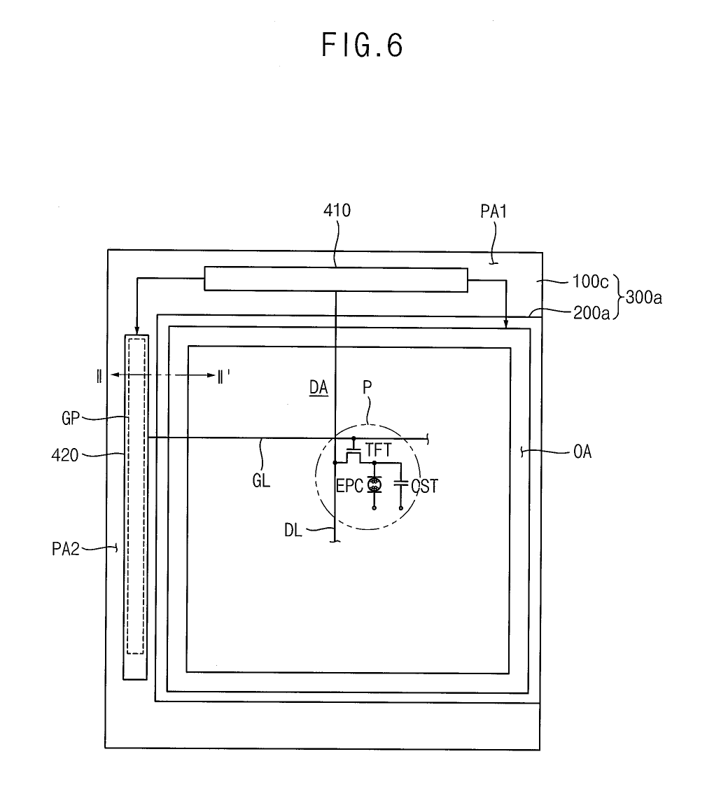

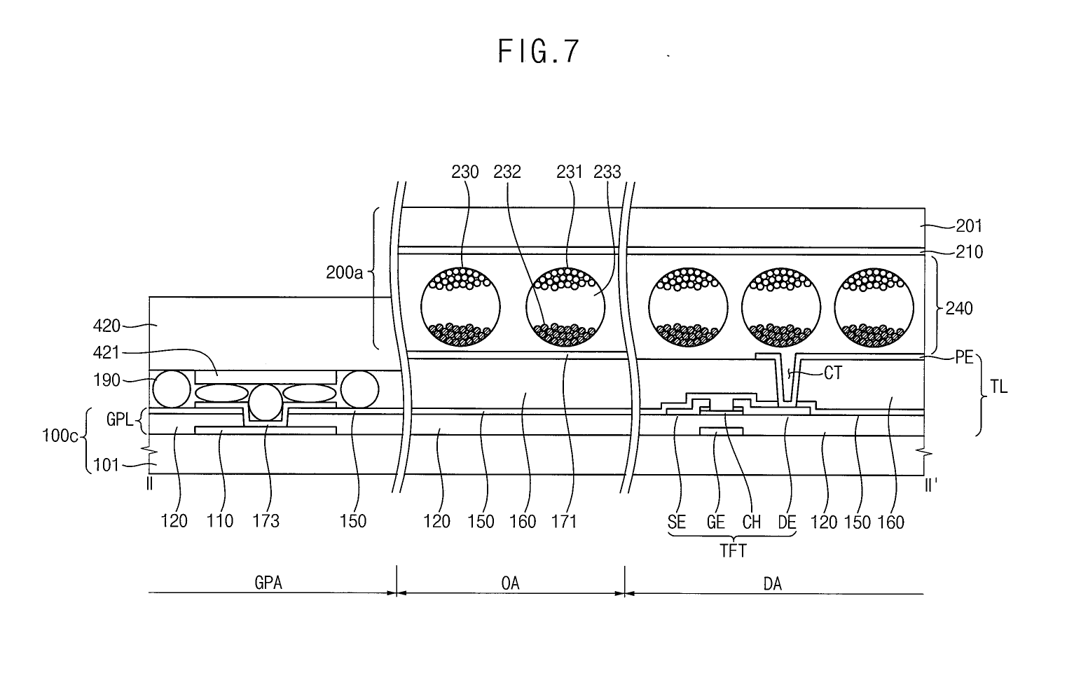

FIG. 6 is a plan view illustrating an electrophoretic display apparatus according to a third embodiment of the present invention. FIG. 7 is a cross-sectional view illustrating the electrophoretic display apparatus according to a third embodiment taken along the line II-II′ of FIG. 6.

Referring to FIGS. 6 and 7, the electrophoretic display apparatus according to the present embodiment includes an electrophoretic display panel 300a, a data driving part 410 and a gate driving part 420.

The electrophoretic display panel 300a includes an array substrate 100c and an electrophoretic layer 200a. The array substrate 100c includes a display area DA and a peripheral area OA surrounding the display area DA.

In the display area, pixel areas P are defined by source lines DL and gate lines GL crossing each other. Each of the pixel areas P includes a thin film transistor TFT electrically connected to the gate line GL and the source line DL, an electrophoretic capacitor EPC electrically connected to the thin film transistor TFT, and a storage capacitor CST electrically connected to the electrophoretic capacitor EPC.

The peripheral area includes a peripheral area OA adjacent to the display area DA and surrounding the display area DA, a first peripheral area PA1 on which a portion of the source lines DL is disposed, and a second peripheral area PA2 on which the driving part 410 and a portion of the gate lines GL are disposed. A gate pad portion GP on which the gate driving part 420 of a chip type is mounted is formed in the second peripheral area PA2.

The blocking electrode is formed in the peripheral area OA. A data voltage corresponding to the black gray scale is applied to the blocking electrode, so the electrophoretic layer will display the black gray scale. The peripheral area OA is displayed with the black gray scale to enhance the view of the image displayed in the display area DA.

The electrophoretic layer 200a includes a transparent common electrode formed on the base substrate having a flexible material, and an electrophoretic layer formed on the common electrode. The electrophoretic layer includes electrophoretic molecules charged with the positive (+) and negative (−) charges. The electrophoretic layer 200a is attached to be overlapped with the display area DA and the peripheral area OA of the array substrate 100.

Particularly, referring to FIG. 7, the electrophoretic display apparatus includes the array substrate 100c and the electrophoretic layer 200a.

The array substrate 100c includes the first base substrate 101, and the first base substrate 101 includes the display area DA, the peripheral area OA and the pad area GPA on which the gate driving part 420 is mounted.

A thin film transistor layer TL is formed in the display area DA. The thin film transistor layer TL includes a gate electrode GE, a gate insulating layer 120, a channel portion CH, a source electrode SE, a drain electrode DE, a protective insulating layer 150, a first organic insulating layer 160 and a pixel electrode PE. The thin film transistor layer TL of the present embodiment is substantially the same as in the embodiment of FIG. 2, and thus any redundant detailed descriptions will be omitted.

The gate insulating layer 120, the protective insulating layer 150, the organic insulating layer 160 and the blocking electrode 171 are sequentially formed in the peripheral area OA. The blocking electrode 171 and the pixel electrode PE are formed at the same time. The black gray scale voltage is applied to the blocking electrode 171 to display the black gray scale. The peripheral area OA displays the black gray scale to enhance the view of the image displayed in the display area DA.

The peripheral area OA of the present embodiment is substantially the same in the embodiment of FIG. 4, and thus any redundant detailed descriptions will be omitted.

A gate pad layer GPL is formed in the pad area GPA. The gate pad layer GPL includes the gate metal layer 110 electrically connected to the gate line GL, the gate insulating layer 120 and the protective insulating layer 150 formed on the gate metal layer 110, a pad electrode 173 electrically connected to the gate metal layer 110 through the contact hole. The pad electrode 173 includes the same material as the pixel electrode PE. The pad electrode 173 electrically makes contact with a terminal 421 of the gate driving part 420 through an anisotropic conductive film 190.

Although the present embodiment is explained in terms of the gate metal layer 110, it is also applicable to the source metal layer electrically connected to the gate line GL. In the source metal layer, the protective insulating layer is formed on the source metal layer, and the pad electrode 173 electrically makes contact with the source metal layer through the contact hole formed in the protective layer.

The electrophoretic layer 200a includes the second base substrate 201, the common electrode 210 and the electrophoretic layer 240. The electrophoretic layer 200a of the present embodiment is substantially the same as in the embodiment of FIG. 2, and thus any redundant detailed descriptions will be omitted.

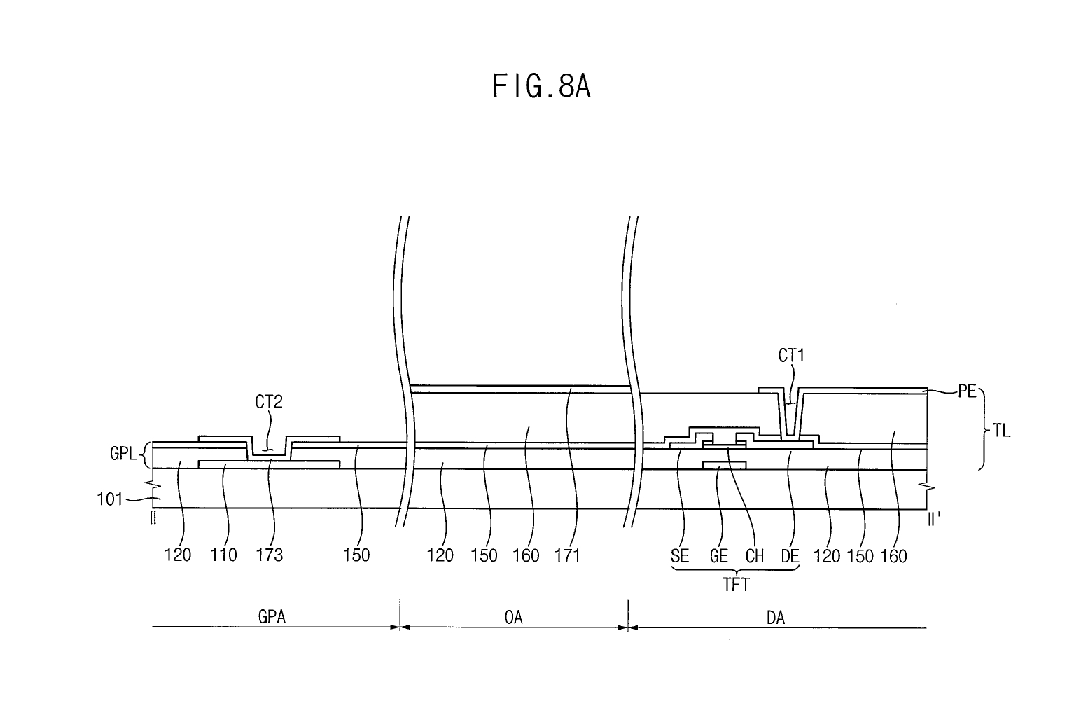

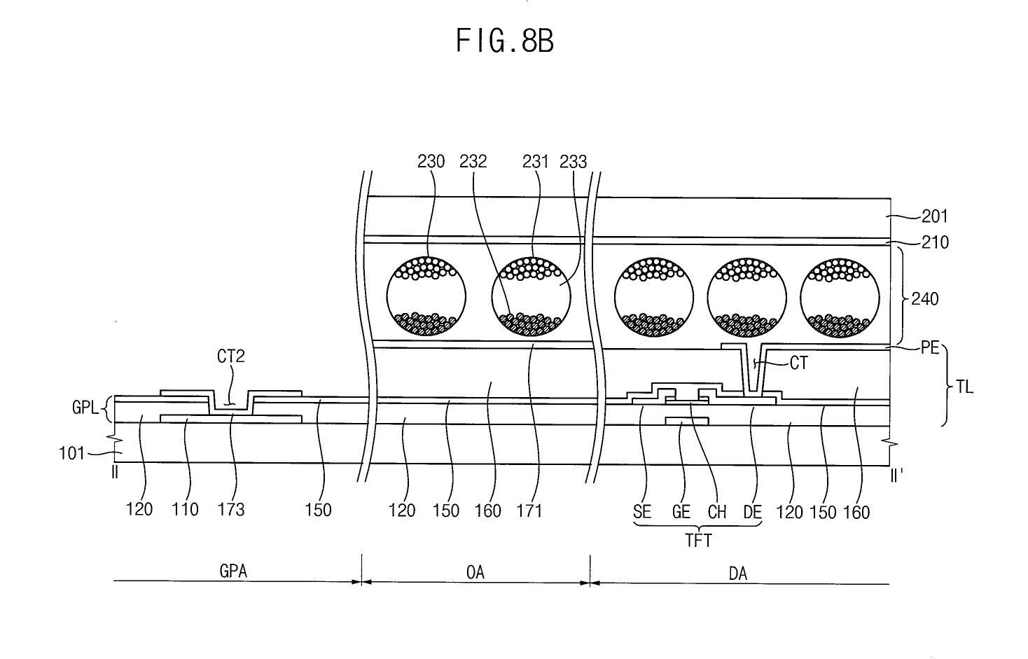

FIGS. 8A and 8B are process views illustrating a method for manufacturing the electrophoretic display apparatus in FIG. 7.

Referring to FIGS. 7 and 8A, the first metal layer is deposited and patterned on the first base substrate 101, to form the gate electrode GE and the gate line LG in the display area DA, and to form the gate metal layer 110 electrically connected to the gate line GL in the pad area GPA.

The gate insulating layer 120 is formed on the first base substrate 101 on which the gate pattern is formed. The gate insulating layer 120 is formed in the display area DA, the peripheral area OA and the pad area GPA in common.

The active layer having amorphous silicon a-Si and the resistant contact layer having amorphous silicon doped with N type dopants at a high concentration are sequentially deposited and patterned on the gate insulating layer 120, to form the channel portion CH in the display area DA. The active layer 131 and the resistant contact layer 132 are not formed in the peripheral area OA and the pad area GPA. The second metal layer is deposited and patterned on the first base substrate 101 on which the channel portion CH is formed, to form the source line DL, the source electrode SE and the drain electrode DE of the display area DA.

The protective insulating layer 150 is formed on the first base substrate 101 on which the source pattern is formed. The protective insulating layer 150 is formed in the display area DA, the peripheral area OA and the pad area GPA in common.

Then, the organic insulating layer 160 having the transparent organic insulating material is formed in the display area DA and the peripheral area OA. However, the organic insulating layer 160 is not formed in the pad area GPA.

The organic insulating layer 160 and the protective insulating layer 150 formed in the display area DA are patterned to form a first contact hole CT1, and the protective insulating layer 150 and the gate insulating layer 120 formed in the pad area GPA is patterned to form a second contact hole CT2.

The transparent conductive material is deposited and patterned on the first base substrate 101 in which the first and second contact holes CT1 and CT2 are formed, to form the pixel electrode PE in the display area DA, to form the blocking electrode 171 in the peripheral area OA, and to form the pad electrode 173 in the pad area GPA. The black gray scale data is applied to the blocking electrode 171 to enhance the view of the image displayed in the display area DA.

The blocking electrode 171 is formed to complete the array substrate 100c. The electrophoretic layer 200a having the electrophoretic layer 240 is laminated to be attached to the array substrate 100c. The electrophoretic layer 200 is attached to cover the display area DA and the peripheral area OA of the array substrate 100c.

The gate driving part 420 (shown in FIG. 6) is mounted on the pad area GPA of the electrophoretic display panel 300a to which the electrophoretic layer 200a is attached, using the anisotropic conductive film 190. The terminal 421 of the gate driving part 420 and the pad electrode 173 is electrically connected with each other by the anisotropic conductive film 190.

Alternatively, the gate driving part 420 is mounted on the pad area GPA, and then the electrophoretic layer 200a is laminated to be attached to the array substrate 100c.

According to the present invention, the blocking electrode is formed in the peripheral area surrounding the display area of the electrophoretic display panel, and the black gray scale data voltage is applied to the blocking electrode to enhance the view of the image displayed in the display area.

In addition, the blocking layer is formed on the gate circuit part to prevent the light from being incident into the gate circuit part integrated in the peripheral area of the electrophoretic display panel, so that the light leakage current may be prevented and driving reliability may be enhanced.

Having described the embodiments of the present invention and its advantage, it is noted that various changes, substitutions and alterations can be made herein without departing from the spirit and scope of the invention as defined by appended claims.

What is claimed is:

1. An electrophoretic display apparatus comprising:
an array substrate comprising a display area having a thin film transistor electrically connected to a gate line and a source line, and a pixel electrode electrically connected to the thin film transistor, and a peripheral area surrounding the display area, the peripheral area having a blocking electrode to block an external light; and
an electrophoretic layer being attached to the array substrate and having an electrophoretic layer.

2. The electrophoretic display apparatus of claim 1, wherein the electrophoretic layer comprises a common electrode facing the pixel electrode.

3. The electrophoretic display apparatus of claim 1, wherein the array substrate further comprises a first organic insulating layer, the first organic insulating layer being formed between the thin film transistor and the pixel electrode in the display area, the first organic insulating layer being formed beneath the blocking electrode in the peripheral area, the first organic insulating layer including a transparent organic insulating material.

4. The electrophoretic display apparatus of claim 1, wherein the blocking electrode comprises the opaque metal material.

5. The electrophoretic display apparatus of claim 1, wherein a black gray scale voltage is applied to the blocking electrode.

6. The electrophoretic display apparatus of claim 5, wherein the blocking electrode comprises a same transparent conductive material as the pixel electrode.

7. The electrophoretic display apparatus of claim 1, wherein the array substrate further comprises:
a gate circuit part formed in an area corresponding to a portion of the gate line to output a gate signal; and
a blocking layer formed on the gate circuit part to cover the gate circuit part, the blocking layer blocking light.

8. The electrophoretic display apparatus of claim 7, wherein the electrophoretic layer covers the display area, the peripheral area and the area in which the gate circuit part is formed.

9. The electrophoretic display apparatus of claim 7, wherein the blocking layer comprises an opaque metal material.

10. The electrophoretic display apparatus of claim 9, wherein the array substrate further comprises a second organic insulating layer formed between the gate circuit part and the blocking layer, and having the transparent organic insulating material.

11. The electrophoretic display apparatus of claim 7, wherein the blocking layer comprises an opaque organic insulating material.

12. The electrophoretic display apparatus of claim 11, wherein the blocking layer is formed to have a same surface height as the first organic insulating layer.

13. A method for manufacturing an electrophoretic display apparatus, the method comprising:
forming an array substrate including a display area having a thin film transistor and a peripheral area having a blocking electrode to block an external light and surrounding the display area;
and
attaching an electrophoretic layer including electrophoretic molecules to the array substrate.

14. The method of claim 13, wherein forming the array substrate comprises:
forming the thin film transistor electrically connected to a gate line and a source line on a base substrate;
forming a first organic insulating layer having a transparent organic insulating material on the base substrate on which the thin film transistor is formed; and
forming a pixel electrode electrically connected to the thin film transistor through a contact hole formed in the first organic insulating layer.

15. The method of claim 14, wherein the blocking electrode is formed on the first organic insulating layer.

16. The method of claim 13, wherein the blocking electrode comprises the opaque metal material.

17. The method of claim 13, wherein a black gray scale voltage is applied to the blocking electrode, and the blocking electrode comprises a same transparent conductive material as a pixel electrode.

18. The method of claim 13, wherein forming the array substrate, comprises:
forming a gate circuit layer outputting a gate signal to the gate line on an area of the base substrate corresponding to a portion of the gate line; and
forming a blocking layer on the gate circuit layer to cover the gate circuit layer.

19. The method of claim 18, wherein attaching the electrophoretic layer comprises attaching the electrophoretic layer to cover the display area, the peripheral area and the area in which the gate circuit layer is formed.

20. The method of claim 18, wherein the blocking layer comprises an opaque metal material.

21. The method of claim 20, further comprising forming a second organic insulating layer having a transparent organic insulating material between the gate circuit layer and the blocking layer.

22. The method of claim 18, wherein the blocking layer comprises an opaque organic insulating material.
